(19) United States
(12) Patent Application Publication
(10) Pub. No.: US 2005/0184879 A1
(43) Pub. Date: Aug. 25, 2005

(54) Remote monitoring system

(76) Inventors: Stacey L. McPherson, Paragould, AR (US); Keith O. Mosbey, Paragould, AR (US)

Correspondence Address: Richard C. Litman;LITMAN LAW OFFICES, LTD., P.O. Box 15035, Arlington, VA, 22215, US

(21) Appl. No.: 10/780,709

(22) Filed: Feb. 19, 2004

(51) Int. Cl. G08B 21/00

(52) U.S. Cl. 340/604; 340/539.1; 340/606

(57) ABSTRACT

The remote monitoring system is provided in the form of an absence of water sensor having an output connected by a signal wire pair to an alarm signal input of a Cellemetry® device that is powered through a second wire pair by an external power source. The sensor is positioned in an outlet of an irrigation pump for sensing the presence and absence of water in the pump outlet and producing alarm signals indicating the presence or absence of water at the pump outlet. Upon receipt of the alarm signals, the Cellemetry® device transmits a programmable message concerning the status and location of the pump directly to a farmer's pager, cell phone or e-mail address at a remote location via the Cellemetry® wireless data communications network.

### BACKGROUND OF THE INVENTION

1. Field of the Invention

The present invention relates to a system for monitoring agricultural equipment and more particularly to a system for the remote monitoring of irrigation pumps and/or wells.

2. Description of the Related Art

In U.S. Pat. No. 6,337,971 B1 issued Jan. 8, 2002 to Abts a system for remotely controlling and monitoring agricultural field equipment and method is taught. The invention comprises a pager message system for monitoring the operation of a plurality of controllers in each one of a plurality of agricultural field equipment. One of a plurality of sensors provided at each location of equipment is connected to one of the controllers for issuing a status signal corresponding to the status of the connected controller. A remote terminal unit transmits the changed status signal, as well as the status of the other sensors, to a central control computer. The computer generates a change of status paging message identifying the equipment having the changed status as well as the unchanged status messages from all remaining equipment at the location. The paging messages are delivered to a pager held by an operator at a remote location. The pager messages are marked so that the operator can identify which piece of equipment had the status change.

The U.S. Patent Application Publication U.S. 2002/0029111 A1 published Mar. 7, 2002 o Peek et al., teaches a cellular weather station and computer system using the public cellular data telephone system and internet for controlling irrigation and method of use. The system of Peek et al. includes a cellular weather station having a data to radio frequency conversion system and at least one sensor, a computer having a collection program for compiling and storing weather information data in data strings, a public cellular telephone system, a server system having a data base and compilation program, an internet network coupled to the server system, a cellular phone system and a personal computer coupled to the internet for entering user information. The server system creates irrigation control information for display on the personal computer.

U.S. Patent Application Publication No. U.S. 2003/0146834 A1 published Aug. 7, 2003 to Stevens et al. teaches a system for monitoring the quality of milk at a dairy facility. Analog and/or digital sensors are installed on equipment that report information through a communication device that sends information by wire-line or wireless telephony to a network operations center. The network operation center interprets the information and determines whether an operator needs to receive an alert or informational message via telephone or other electronic communications device such as personal computers, CE computing devices, Palm® platform devices and printers.

In U.S. Pat. No. 6,553,336 B1 issued Apr. 22, 2003 to Johnson et al. a smart remote monitoring system and method is taught which includes self-identifying, plug-and-play transducers, a wired or wireless local area network (LAN) connecting the transducers to a transducer control module which connects the transducers via the LAN to a communications device which connects the transducer control module through a wide area network (WAN) to a monitoring system and end-user display terminals. The system can be used to provide real-time on-demand status information to end-users and alarm notifications to the end-user and other appropriate entities. The alarm notifications may be provided by telephone, telegraph, facsimile, pager, electronic mail, or other communications devices.

None of the above inventions and patents, taken either singly or in combination, is seen to describe the instant invention as claimed. Thus a remote monitoring system solving the aforementioned problems is desired.

### SUMMARY OF THE INVENTION

The remote monitoring system of the present invention comprises an absence of water sensor, a Cellemetry® device and a power source for the Cellemetry® device. The sensor is positioned in the outlet of an irrigation pump for monitoring the flow of water from the pump. The sensor produces a first alarm signal when no water is detected in the pump outlet and a second alarm signal when water is subsequently detected. The Cellemetry® device is positioned near the pump to receive the alarm signals at an alarm signal input from a sensor output wire pair. Upon receipt of the alarm signals from the sensor, the Cellemetry® device transmits a programmable message concerning the status and location of the pump directly to a farmer's pager, cell phone and/or e-mail address at a remote location via the Cellemetry® wireless data communications network. After the pump has been restored to operation, the sensor produces an alarm signal that water has been restored triggering the Cellemetry® device to transmit a equipment restored message to the farmer's pager, cell phone and/or e-mail address.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a remote monitoring system according to the present invention.

FIGS. 2A, 2B and 2C are illustrations of the pathways of notification for the remote monitoring system of the present invention.

Similar reference characters denote corresponding features consistently throughout the attached drawings.

### DETAILED DESCRIPTION OF THE PREFERRED EMBODIMENT

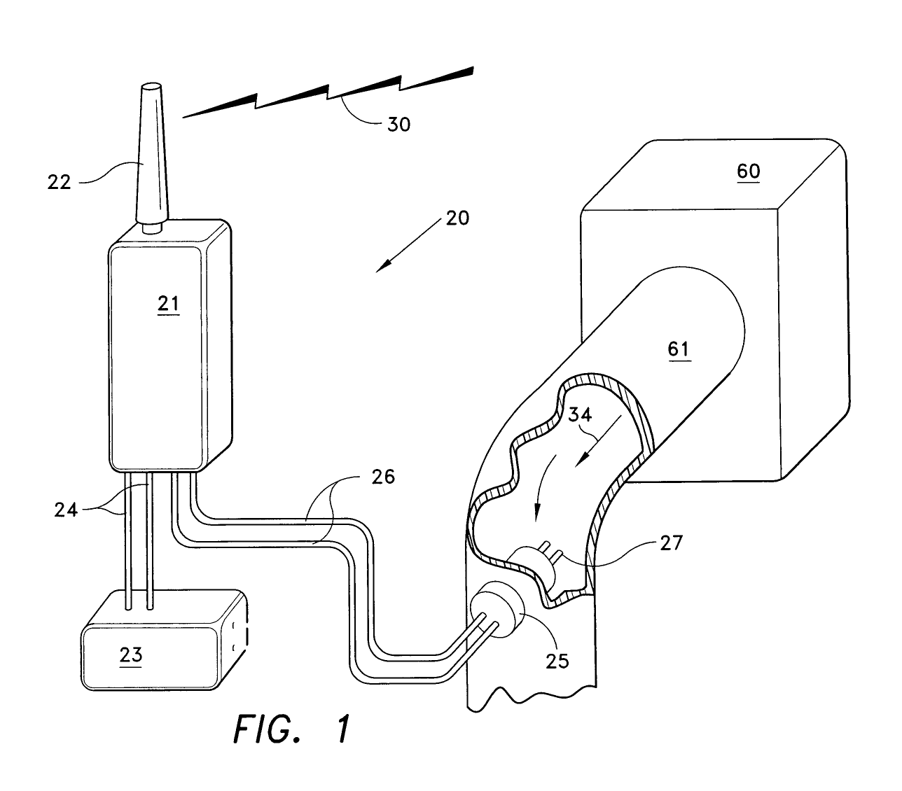

FIG. 1 shows how the remote monitoring system 20 of present invention is employed for remotely monitoring a piece of farm equipment 60 which in this case is an irrigation pump and/or associated equipment. System 20 is provided in the form of an absence of water sensor 25 connected by a signal wire pair 26 to a Cellemetry® device 21 that is powered through a second wire pair 24 by an exterior power source 23.

Power Source 23 may be provided in the form of a 12-volt battery or 12-volt power supply connected to a local AC source. The battery of the pump 60 or associated equipment is also a suitable source of power.

The sensor 25 is positioned in an outlet 61 of an irrigation pump 60 for monitoring the presence and absence of water flow 34 in the pump outlet 61. Sensor 25 is self-powered and continuously monitors for the presence and/or absence of water in pump outlet 61. The sensor 25 produces a first alarm signal when no water is detected between a pair of sensor probes 27 and a second alarm signal when water is again detected. The sensor is preferably the commercially available GRI-2808 absence of water detector produced by George Risk Industries.

The alarm signals are transmitted to Cellemetry® device 21 along a signal wire pair 26 connecting the signal output of sensor 21 to the signal input of device 21 positioned near the pump. Upon receipt of the alarm signal, the Cellemetry® device 21 transmits a cellular signal 30 containing a programmable message concerning the status and location of the pump 60 to the Cellemetry® Data Service. Cellemetry® device 21 is preferably the commercially available Uplink^{sm} DigiCell® 1500 Universal Alarm Transceiver. The signal is transmitted via at least two of three pathways provided by the Cellemetry® Data Service directly to a remotely located farmer. The farmer is notified of the identity of the pump having no water so that repairs can be initiated on the pump or associated equipment then thereafter notified of the restoration of the identified pump or associated equipment when water is again detected.

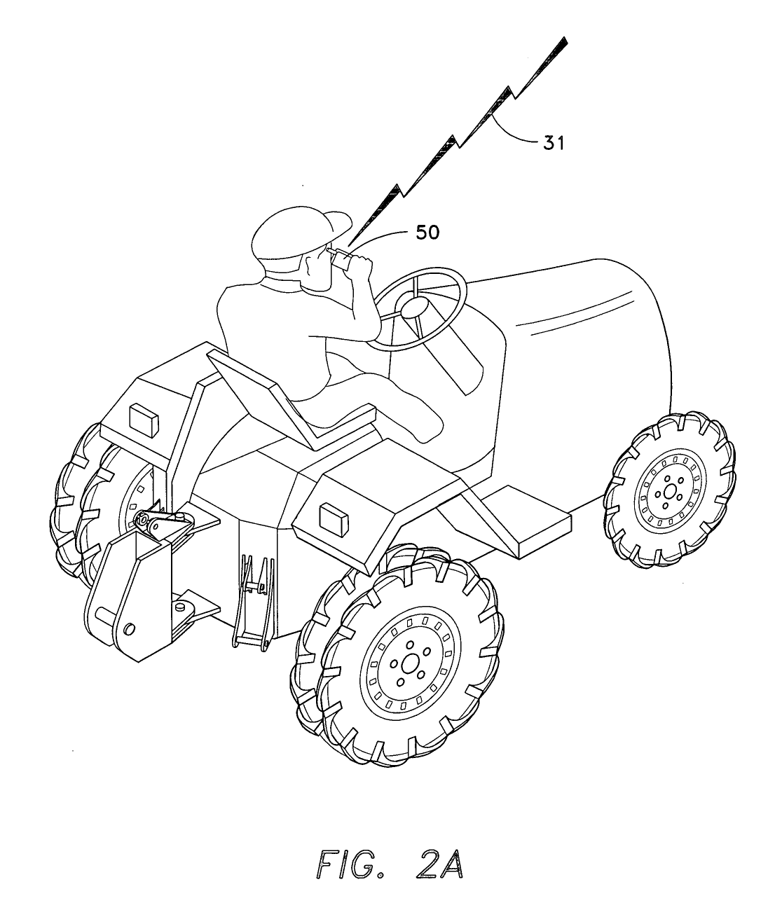

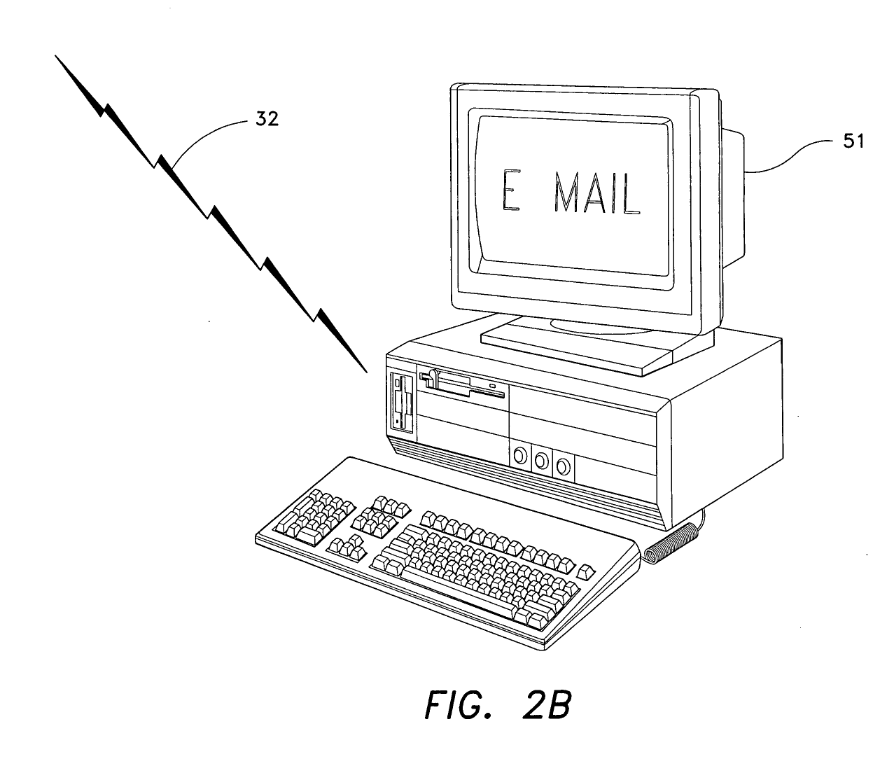

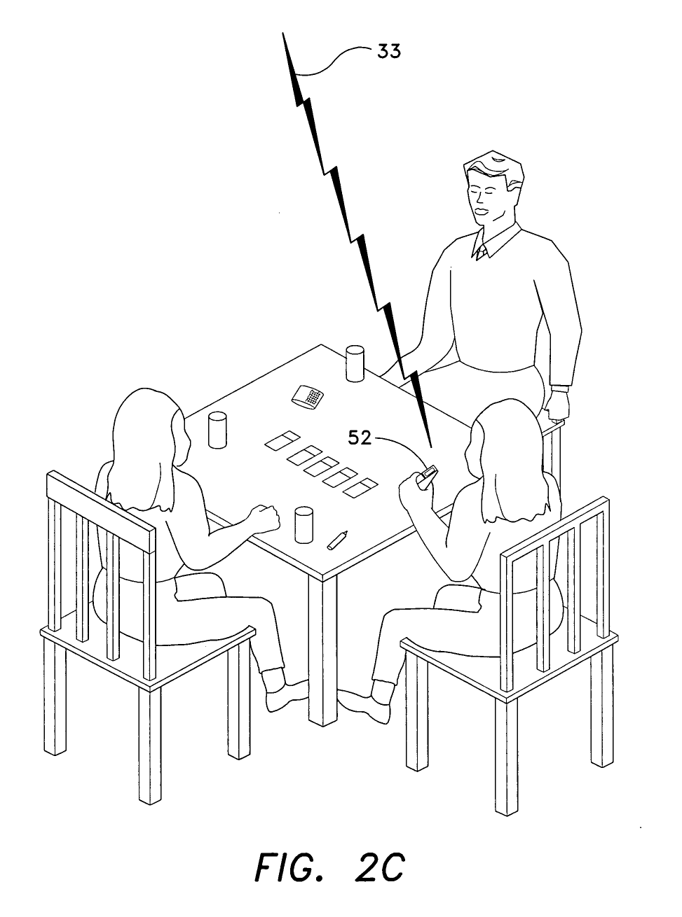

The various pathways of remote communication of the notification to the farmer are illustrated in FIGS. 2A-2C. In FIG. 2A a first path 31 is shown from Cellemetry® Data Service to the farmer's cellular phone 50. A second pathway 32 is shown in FIG. 2B from the Cellemetry® Data Service to the farmer's e-mail address via the Internet. The farmer can receive the e-mail notification messages using a portable or home computer 51. FIG. 2C shows a third pathway 33 available from the Cellemetry® Data Service for communicating notification messages to the farmer is via the farmer's alphanumeric pager 52. The notification may also be delivered by facsimile or other suitable means selected by the farmer.

It is to be understood that the present invention is not limited to the embodiment described above, but encompasses any and all embodiments within the scope of the following claims.

1. A remote monitoring system, comprising:
an absence of water sensor for sensing the presence and absence of water in a pump outlet and producing alarm signals indicating the presence or absence of water at the pump outlet;
a Cellemetry® device for transmitting programmable messages concerning the status and location of the pump directly to a farmer's pager, cell phone or e-mail address at a remote location via the Cellemetry® wireless data communications network; and
a signal wire pair connecting a signal output of said sensor to a signal input of said Cellemetry® Device.

2. The remote monitoring system according to claim 1, wherein said absence of water sensor is self powered.

3. The remote monitoring system according to claim 1, wherein said Cellemetry® device comprises an Uplink^{sm} DigiCell® 1500 Universal Alarm Transceiver.

4. The remote monitoring system according to claim 1, wherein said absence of water sensor is a GRI-2808 absence of water detector.

5. The remote monitoring system according to claim 1, wherein said Cellemetry® device comprises an Uplink^{sm} DigiCell® 1500 Universal Alarm Transceiver; and said absence of water sensor is a GRI-2808 absence of water detector.

6. The remote monitoring system according to claim 1, further including an external power source providing power to said Cellemetry® device through a second wire pair.

7. The remote monitoring system according to claim 6, wherein said power source is a 12-volt battery.

8. The remote monitoring system according to claim 6, wherein said power source is a 12-volt power supply.

9. The remote monitoring system according to claim 2 further including an external power source providing power to said Cellemetry® device through a second wire pair.

10. The remote monitoring system according to claim 9, wherein said power source is a 12-volt battery.

11. The remote monitoring system according to claim 9, wherein said power source is a 12-volt power supply.

12. The remote monitoring system according to claim 3 further including an external power source providing power to said Cellemetry® device through a second wire pair.

13. The remote monitoring system according to claim 12, wherein said power source is a 12-volt battery.

14. The remote monitoring system according to claim 12, wherein said power source is a 12-volt power supply.

15. The remote monitoring system according to claim 4, further including an external power source providing power to said Cellemetry® device through a second wire pair.

16. The remote monitoring system according to claim 15, wherein said power source is a 12-volt battery.

17. The remote monitoring system according to claim 15, wherein said power source is a 12-volt power supply.

18. The remote monitoring system according to claim 5, further including an external power source providing power to said Cellemetry® device through a second wire pair.

19. The remote monitoring system according to claim 18, wherein said power source is a 12-volt battery.

20. The remote monitoring system according to claim 19, wherein said power source is a 12-volt power supply.
